(19) United States
(12) Patent Application Publication
(10) Pub. No.: US 2012/0197748 A1
(43) Pub. Date: Aug. 2, 2012

(54) Barter System with a Master User

(76) Inventor: Scot Vorse, Los Angeles, CA (US)

(21) Appl. No.: 13/348,132

(22) Filed: Jan. 11, 2012

Related U.S. Application Data
(60) Provisional application No. 61/438,636, filed on Feb. 1, 2011.

(51) Int. Cl. G06Q 30/08

(52) U.S. Cl. 705/26.3

(57) ABSTRACT

A barter system for transferring physical assets between related entities utilizes a distributed computer network using a master user. The system utilizes a database of designated physical assets, or optionally services, a transfer value for each asset, a list of the related entities, and an account for each entity, the account for containing points to obtain physical assets from another related entity. Each entity has at least one remote computer the remote computers operably connected to the database for (i) providing a list of physical assets available for transfer limited to designated physical assets in the database; and (ii) requesting transfer of physical assets listed in the database.

### CROSS-REFERENCE TO RELATED APPLICATIONS

The present application is a non-provisional patent application and claims the benefit of U.S. Provisional Patent Application No. 61/438,636, titled “Barter System With A Master User,” filed Feb. 1, 2011; the contents of which are incorporated in this disclosure by reference in their entirety.

### BACKGROUND

The present invention relates to a method, a programmable device and a system for bartering for items between two or more related parties using a master user.

Bartering is one of the oldest forms of exchange. Originally, bartering systems allowed participants to trade one's own products for another's products. For example, in a traditional barter exchange, a farmer traded corn or wheat in exchange for tools produced by a blacksmith or medical services provided by a doctor. The problem tended to be that barterers needed to find someone to barter with who had the product they wanted and who wanted their product. If a person had blankets to trade and wanted cotton, they not only had to find someone that had cotton, but also someone with cotton that wanted blankets. Also, barter exchanges often have no sellers willing to sell at the same time a buyer wants to buy or no buyers willing to buy at the same time a seller wants to sell. The absence of constant buyers and sellers makes it exceedingly difficult for trading to be as smooth and continuous or as liquid as possible. Another problem is that conventional barter exchanges often involve unique products which may or may not satisfy the buyer's specific needs. These continuing problems significantly reduce the liquidity, efficiency and effectiveness of a barter trading system.

As civilizations evolved and trade became more complex, society found it more efficient to use a common currency to exchange products. Currency or cash allows participants to trade their products for set values of the currency. Currency can then be re-exchanged for other products at a different time and place. As a result of its liquidity, the currency exchange system has become the dominant method to complete transactions. With currency exchange dominance, barter exchange decreased and further reduced this markets liquidity.

Furthermore, barter trading today is a time consuming process. First, a participant must learn how to use and navigate the exchange. Once a participant learns how to use and navigate the barter system, they must also operate the system which includes selecting what items should be sold, creating and uploading descriptions, specifications and photos, determining pricing and bidding strategies, comparing various products being offered, monitoring the auctions, negotiating with other participants and revising their barter strategies. Further, conventional barter exchanges do not tightly control and limit what specific goods and services can be sold on its exchange. Therefore, products are often fragmented, non-standardized, voluminous and in different physical condition requiring the participants to spend significant time, effort and expertise to evaluate the suitability and value of each product. Also, the individual within an organization responsible for executing this time consuming system is often not the person that directly benefits from the trading. This flawed system discourages participation in barter exchanges and, with fewer participants offering fewer products, further reduces liquidity.

Lack of liquidity creates numerous problems for a barter system including reducing the number of potential transactions and likelihood a transaction occurs, slowing the speed at which a transaction occurs, and reducing the probability of achieving market and reasonable terms. These problems deter additional participants which reduce the liquidity even more.

Often barter system participants are related as part of a partnership, alliance, association or common ownership and share a common objective. In spite of this common objective, existing barter systems only benefit participants to the extent of their individual benefit. There is no method or entity to coordinate the participants toward a common objective. For example, if imbalances exist between the supply and demand for a particular product across the entire barter system, there is no mechanism or entity to identify and correct these supply and demand imbalances.

The barter exchange system continues to survive despite the dominance of the currency exchange system. Barter systems are often the best alternative system when participants are lacking cash, want to avoid certain cash outlays and reduce expenditures, or when using a currency system is not legal, appropriate or practical.

The advent of distributed computer systems such as the Internet, sophisticated database software programs and virtual currencies has attempted to address these problems. However, despite all the advancement in technology, the systems that are currently available, fail to provide a liquid, efficient and effective marketplace in which parties may barter directly with one another and to provide a mechanism or entity to coordinate the operations of the barter system in the best interests of the combined group.

For the forgoing reasons, there is need for a method, a programmable device and system that can inexpensively improve the liquidity, efficiency and effectiveness of barter exchanges and coordinate the operations of the barter exchange in the best interests of the combined group.

### SUMMARY

The present invention is directed to a process that satisfies the need for better liquidity, efficiency and effectiveness and coordination of barter exchanges. The process comprises a method, a programmable device and a system for bartering for items between two or more parties.

In the present invention, an administrator controls and maintains a database enabling bartering between third parties, also referred to as entities or users. In the database there is a menu of goods, and optionally services, available for trading, and the goods and services have a set price (also referred to as points). The barter exchange controlling entity or “master user” determines what goods and services can be exchanged, uploads to the database the basic descriptions—and “purchase” price (also referred to as a transfer value) or points of these goods and services. Preferably only the master user can change the goods and services listed their price or points and a basic description. Optionally, the master user may upload a more detailed description and/or “representative” photo(s) to the database regarding a barterable item for bartering with the system. Furthermore, optionally the master user can list in the database excess merchandise it wants to sell and the master user can purchases any or all the excess inventory. The master user also provides each user in the system an account for points which optionally can contain a predetermined amount of start-up points that can be used for acquiring inventory. In addition to increasing liquidity and trading, the master user can eliminate supply and demand imbalances by buying any or all excess supply of product or selling excess demand of product throughout the entire barter system. Also the master user can provide bonus points for listing of inventory by a certain date to encourage early listing of merchandise.

Each user can access the database to upload the number of goods it has available for “sale”, and upload the number of goods it wants to “purchase”. Preferably the identity of the user is anonymous, i.e., none of the other users (except the master user) knows who is offering and/or purchasing the particular goods. Optionally the master user does not know who is offering and/or purchasing the goods. This is so users are not penalized for having excess inventory and are willing to participate in the barter system.

In a preferred version of the invention, the master user automatically purchases all items listed by a user that are on an approved list of merchandise (and that are confirmed by the master user as consistent with the approved item) for a set amount of points per item. Thus the user receives immediate credit. A user can also submit an item that is not already on the approved list for inclusion on the list of merchandise that can be bartered. If that submitted item is approved for inclusion by the master user, it can be included from that date forward on the approved list of merchandise that can be bartered. Optionally, if the merchandise purchased by the master user is not sold to a regular user within a specified time interval such as sixty day, the credit is reversed. Also the merchandise can be removed from the database.

In one aspect of the invention, a barter system for transferring physical assets between related entities utilizes a distributed computer network. The system comprises one or more machine readable medium containing a database of designated physical assets, a transfer value for each asset, a list of the related entities, and an account for each entity, the account containing points to obtain physical assets from another related entity. The system also includes an administrative computer means operably connected to the database for maintaining the database, and at least one remote computer means for each of the related entities. The remote computers means are operably connected to the database for (i) providing a list of physical assets available for transfer limited to designated physical assets in the database; and (ii) requesting transfer of physical assets listed in the database.

Optionally the system can include a processor for deducting from the account of each entity transferring physical assets the transfer value for the physical assets received by that entity. Optionally the same or different processor can allow for crediting the account of each entity transferring physical assets the transfer value for the transferred physical assets by that entity. Preferably the administrative computer means does not reveal the identity of any entity to another entity (except the master user). Also preferably the remote computers when providing a list of physical assets available for transfer maintains the identity of the entity anonymous.

The account for at least one entity optionally can contain transfer points before that entity transfers any physical assets and before that entity provides a list of physical assets available for transfer. The account for at least one entity can optionally contain transfer points after that entity provides a list of physical assets available for transfer and before that entity actually transfers any physical assets.

A method utilizing such a system can comprise the steps of: a) providing a set of designated physical assets subject to transfer, and a transfer value for each asset; b) providing at least some of the entities an account containing points to obtain physical assets from another related entity; c) receiving from at least one offering entity a list of physical assets available for transfer by the entity, the list being limited to the designated physical assets in the set; d) receiving from at least one requesting entity a request to receive physical assets available for transfer; e) transferring from the offering entity at least one of the physical assets listed as available for transfer to the requesting entity; and f) deducting from the account of the requesting entity the transfer value for the physical asset received by requesting entity. The method can optionally include the step of adding to the account of the offering entity the transfer value for the physical asset being transferred by the transferring entity if this was not already performed.

### DRAWINGS

These and other features, aspects, and advantages of the present invention will become better understood with regard to the following description, and accompanying drawings, where:

FIG. 1 shows a block diagram of an exemplary system in accordance with one embodiment of the present invention.

FIG. 2 shows a general flow chart of one exemplary method for the master user of a barter system with a master user in accordance with one exemplary embodiment of the present invention.

FIG. 3 shows a general flow chart of one exemplary method for a user of a barter system with a master user in accordance with one exemplary embodiment of the present invention.

### DESCRIPTION

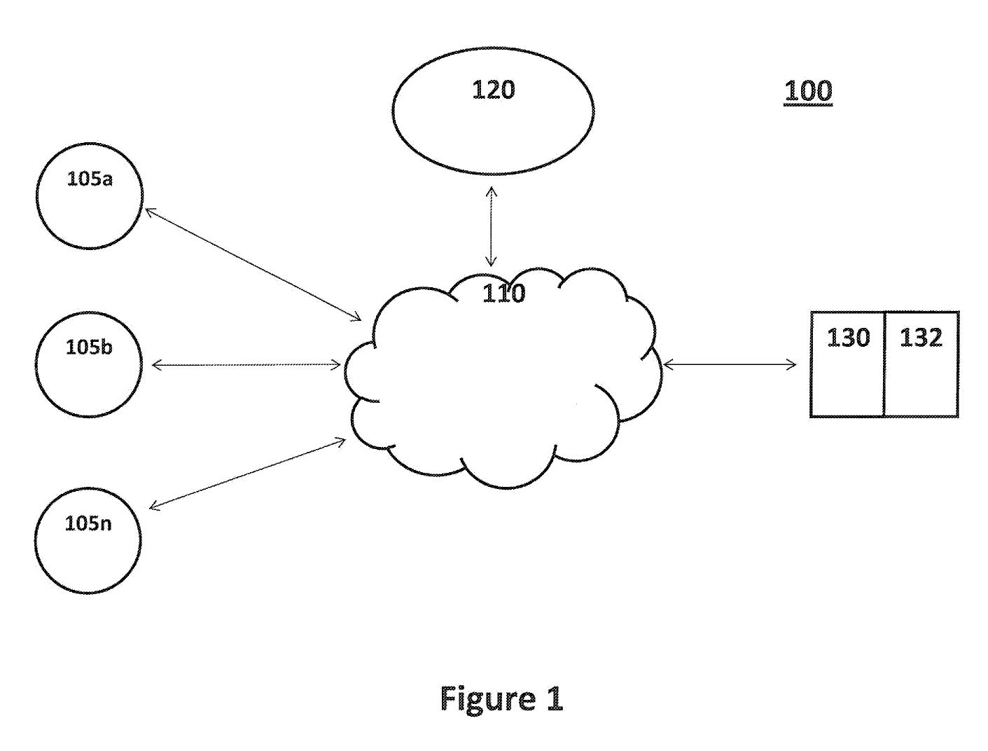

FIG. 1 shows a block diagram of an exemplary system in accordance with one embodiment of the present invention. The system 100 generally includes at least a first user 105a. The system 100 may additionally include at least a second user 105b, and additional users, also referred to as customers, up to customer 105n, where n represents any number of customers practical for operation of embodiments of the present invention. The system 100 also comprises a master user 120 which is a user 105 and in one embodiment of the present invention the master user determines what items can be bartered and enters the basic descriptions of the items that can be bartered and sets the prices for the items that can be bartered. The system 100 further comprises an administrator 130, i.e., an organization, company or individual who is generally responsible for implementing and/or facilitating each of the methods disclosed herein. Optionally, the master user may upload a detailed description and/or “representative” photo(s) to the database regarding a barterable item for bartering within the system. Typically the master user works for the administrator, the administrator works for the master user or the master user and administrator work for the same entity.

As is common in network-based business models, the administrator 130 may also be responsible for maintaining a website or interactive portal through which all of the users 105 of the system 100 may interact and execute the methodology or functionality in the embodiments disclosed herein.

The network 110 may comprise any network suitable for embodiments of the present invention. For example, the network 110 may be a part or full deployment of most any communication or computer network or link, including any multiples of a public or private, terrestrial wireless or satellite and wire line links. The network may include the Internet, core and proprietary networks, wireless voice and packet-data networks, and the like.

The embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed.

A process may correspond to a method, a function, a procedure, a subroutine, a subprogram, etc. When a process corresponds to a function, its termination corresponds to a return of the function to the calling function or the main function.

Moreover, a storage or storage medium may be one or more devices for storing data, including read-only memory (ROM), random access memory (RAM), magnetic disk storage mediums, optical storage mediums, flash memory devices and/or other machine readable mediums for storing information.

Furthermore, embodiments may be implemented by a distributed computer network such as the internet, including by use of hardware, software, firmware, middleware, microcode, or a combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

In the following description, certain terminology is used to describe certain features of one or more embodiments of the invention.

The term “machine readable medium” and “computer readable medium” includes, but is not limited to portable or fixed storage devices, optical storage devices, wireless channels and various other mediums capable of storing, containing or carrying instruction(s) and/or data.

The term “computing device” includes, but is not limited to computers, cellular telephones, hand held computers and other devices that are capable of executing programmed instructions that are contained in a storage including machine readable medium.

The administrator 130 may comprise any person, business or entity capable of performing and administrating the methods disclosed herein. In one embodiment, the administrator 130 is an entity hosting an accessible server and a database 132. The server may comprise any type of computing device suitable for embodiment of the present invention. The server may be located at the administrator 130 physical site or at a remote location accessible via the network 110.

The database 132 may include a number of records in accordance with the present invention, including data and/or information, which may be parsed or stored. The database 132 may further comprise software, which may include and/or employ one or more database management systems.

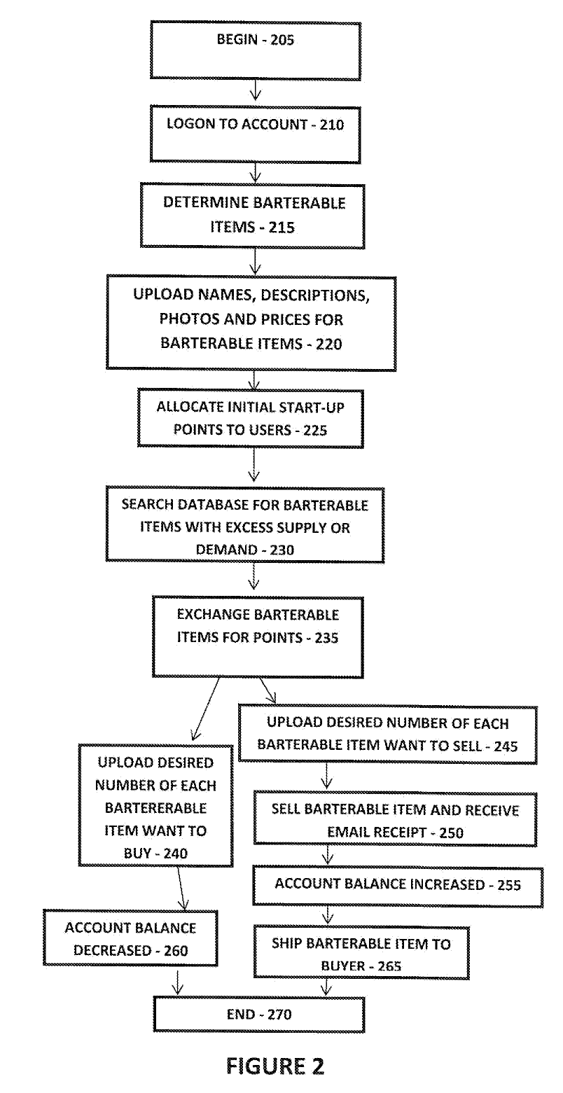

FIG. 2 shows a general flow chart of one exemplary method for the master user 120 of a barter system with a master user in accordance with one exemplary embodiment of the present invention. The method 200 begins with step 205. At step 210, the master user 120 may logon to the master user account generally hosted by the administrator 130. Upon validation by the administrator 130, the master user 120 may be directed to its account within the system 100. At step 215, the master user 120 determines what items can be bartered or the “barterable items”.

At step 220, once logged into the master user account, the master user 120 may upload data to the database 132 regarding a barterable item for bartering within the system 100 which generally includes providing a description, pricing or point value and other characteristics of the barterable item. Optionally, the master user 120 may upload a more detailed description and/or “representative” photo(s) to the database 132 regarding a barterable item for bartering within the system 100.

Optionally, at step 225, the master user 120 uploads data to the database 132 regarding the number of initial start-up points each user 105 will be allocated. This step is optional in that a user may not receive start-up points. Instead, or in addition to start-up points, a user can list items for barter and immediate receive points for those items even before trading of these items begin. Optionally, a user 105 may receive additional bonus points for listing an item even before trading of these items begin. For example, a user 105 may receive 125 points for listing an item before trading of these items begin with a transfer value of 100 points.

At step 230, the master user 120 may search the database 132, through a specified category (e.g., books, desks, etc.) or through a general search engine provided by the administrator 130, for barterable items with excess supply or demand for barterable items by the users 105.

At step 235, the master user 120 is permitted to barter the barterable items for one or more of the barterable items desired from users 105 by utilizing the system 100.

At step 240, the master user 120 uploads data to the database 132 regarding the desired number of each barterable item identified in step 230 it wants to buy from other users 105.

At step 245, the master user 120 uploads data to the database 132 regarding the desired number of each barterable item identified in step 230 it wants to sell to other users 105.

At step 250, upon a sale of a barterable item to a user 105, the master user 120 receives a notification, generally by email, that a user 105 has “bought” an item from the master user 120. The notification will generally include the user 105 name, address and contact information, the master user 120 name, address and contact information, description of item bought, total number of items bought, total purchase price or points, transaction date and transaction identification number provided by administrator 130.

At step 255, the administrator 130 increases the account balance on the database 132 of the master user 120 that sold the barterable item by an amount equal to the total purchase price or points for the transaction in step 250.

At step 260, the administrator 130 decreases the account balance on the database 132 of the user 105 that bought the barterable item by an amount equal to the total purchase price or points for the transaction in step 250.

At step 265, the master user 120 ships to the user 105 the barterable item purchased in step 250. Alternatively, the user having the item can ship it directly to the purchaser or the purchaser can pick up the item if anonymity is not desired.

The method 200 ends at step 270.

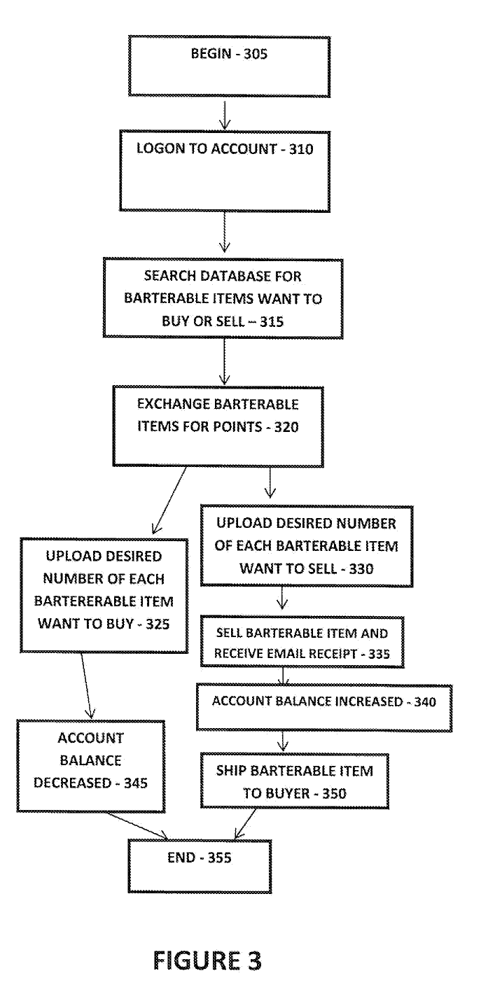

FIG. 3 shows a general flow chart of one exemplary method for a user 105 of a barter system with a master user 120 in accordance with one exemplary embodiment of the present invention. The method 300 begins with step 305. At step 310, the first user 105a may log into an account generally hosted by the administrator 130. Upon validation by the administrator 130, the first user 105a may be directed to its account within the system 100.

At step 315, the first user 105a may search the database 132, through a specified category (e.g., books, desks, etc.) or through a general search engine or similar mechanism provided by the administrator 130 for a barterable item it wants to buy or sell.

At step 320, the first user 105a is permitted to barter the barterable items for one or more barterable items of other users 105 and/or the master user 120 utilizing the system 100.

At step 325, the first user 105a uploads data to the database 132 regarding the number of each barterable item identified in step 315 it wants to buy from other users 105.

At step 330, the first user 105a uploads data to the database 132 regarding the number of each barterable item identified in step 315 it wants to sell to other users 105.

At step 335, upon a sale of a barterable item to a second user 105b, the first user 105a receives a notification, generally by email, that the second user 105b has “bought” an item from the first user 105a. The notification can include the first user's 105a name, address and contact information, the second user's 105b name, address and contact information, description of items bought, total number of items bought, purchase price or points, transaction date and transaction identification number provided by administrator 130. If anonymity is desired, then limited information is exchanged.

At step 340, the administrator 130 increases the account balance on the database 132 of user 105a that sold the barterable item by an amount equal to the total purchase price or points for the transaction in step 335 if the user 105a did not already receive credit for the item sold.

At step 345, the administrator 130 decreases the account balance on the database 132 of user 105b that bought the barterable item by an amount equal to the total purchase price or points for the transaction in step 335.

At step 350, the first user 105a ships to the second user 105b the barterable item purchased in step 335.

The method 300 ends at step 355.

The steps need not be performed in this order and many of the steps can be performed simultaneously.

Although the present invention described below is with regard to a school district, where each separate school is a user, it has many other applications. These applications include governmental, quasi-governmental and non-governmental entities having multiple facilities or departments, where each separate facility or department is a user. The entity can be a public or private company having multiple facilities or departments, where each separate facility or department is a user. The entity can be an individual that may have centrally purchased and allocated assets, limited or incorrect information regarding what assets their individual units own, standardized goods and products, or no or minimal economic cost for the individual units, divisions, subsidiaries, members or the like (the “units”) to keep or an incentive to return any excess assets.

Optionally the master user can purchase items as soon as they are listed for sale by an offering user without waiting for a purchase by a requesting entity to provide liquidity.

The example of the present invention is an online barter exchange that allows a school district main office and the schools within that district to “sell” surplus items and “buy” needed items without spending money. Many schools districts have no or poor inventory systems, ineffective intra-district procurement communications, limited systems to determine what individual school owns and needs, no incentive for schools to return to the main district office excess products or poor product requisite systems.

Optionally, each school receives an initial amount of “virtual dollars” or points to buy surplus items from the district main office and other schools throughout its school district. Also optionally each school can be allowed to run a deficit in their account to provide liquidity to the system. Preferably there is a cap on the deficit.

By limiting bartering on this exchange to only schools within the district, the exchange creates a “closed system”. The closed system provides a mechanism for the main district office to coordinate efficiently the operations in the best interests of the overall district. Schools may earn additional points by selling its surplus items to others schools or back to the main district office. These earned points may be used to buy additional needed items. The barter exchange uses a web-based auction that is simple to use and benefits from the fact that schools within the same district often use much of the same or similar equipment and supplies. With standardized products, the website includes preloaded product basic descriptions and prices requiring the school to enter a limited amount of information including the number of each item it wants to buy or sell only. Optionally, the master user 120 may upload a more detailed description and/or a “representative” photo to the database 132 regarding a barterable item for bartering with the system 110.

Each school can be given a certain number of points to “prime the pump” or can immediately receive credit for listed items to prime the pump. The initial allotment of points represents enough points to initiate the buying process but not too large that schools lose their incentive to offer their excess products. The main district office will determine the initial list of barterable products with input from the individual schools. The trading exchange includes the most standardized, high volume, high priced items which can be shipped efficiently and are least subject to wear and tear. The exchange may add products over time as schools suggest additional items to exchange. Each school has its own account with user name, password, etc. Each item is pre-assigned by the main district office a specific point value based on its relative list price. There is no need for a detailed inventory process or search. A school may buy a few extra books or offer another product as quickly or as slowly as it wants.

Once a purchase is completed, both the buying and selling school receive a notification receipt, generally an email, which lists the selling school, buying school, contact information, order identification number, summary of traded items and transaction cost. The selling school packs the sold items in a pre-provided box, inserts the notification receipt in the pre-provided envelope and attaches the envelope to the shipping box. Periodically, the boxes are collected from the selling schools and shipped to the buying schools. Or the master user can receive sold items and distribute them.

In addition to providing pricing, product descriptions and optionally photos, the main office, referred to above as a master user, acts as a “market maker”. In this role, the main district office may buy excess product listed on the exchange either immediately when offered for sale by a school or when no individual school is offering to buy that product. Also, the main district office may offer to sell its excess product to the exchange when no individual school is offering to sell that product. This function increases the liquidity of the barter exchange by providing a constant buyer and seller of product. Not only will this better match the needed resources of each school within the district, but also will reduce wasteful purchases by the main district office. Specifically, main districts offices often have no effective method to determine what items it is overbuying. For example, if the exchange database shows that hundreds of surplus 2nd grade math books are being offered for sale, the main district office knows that it has historically bought too many 2nd grade math books. The main district office can buy these excess books from the individual schools with virtual money or points and reduce its future purchases of 2nd grade math books with real money. The potential reduction in wasted purchases is significant and these savings can be spent on other products that the schools within the district need.

The schools' names can be anonymous, i.e., none of the other schools or users of the exchange (except the master user) knows who is offering the particular goods. This can be accomplished by providing each user (school) with a code designation so that no other school or user of the exchange (except the master user) knows the identity of the school selling items. This is so a school will not get penalized for having excess inventory and will be willing to participate in the barter system. Thus a list of items to transfer can be provided anonymously, i.e. the identity of the offering school is not known by any other user and optionally by the master user.

The previously described versions of the present invention have many advantages including, without limitation:

The present invention is a highly liquid, efficient and effective barter system. The master user 120 may search the database 132 provided by the administrator 130 for barterable items with excess supply or demand. Based on the excess supply and demand, the master user 120 can buy from users 105 barterable items with excess supply and sell to users 105 from its inventory barterable items with excess demand. The system 100 items currently has no effective method to determine what barterable items it is over buying. However, with the present invention, the master user 120 can determine that the system 100 has excess supply and buy this barterable item from users 105 with virtual money or points and reduce its purchase of this barterable item with real money in future years.

The present invention allows the master user 120 and user 105 to learn what the overall exchange and the individual users 105 own to determine what it actually owns and over time develop a quasi-inventory system. This allows the master user 120 to determine not only what it is overbuying or under buying barterable items and adjust its purchasing.

The present invention is easy to use, navigate and is not time consuming. The master user 120 in one embodiment of the present invention uploads all the required data to the database 132 regarding what items are barterable including the description, photos, pricing or point value and other characteristics of the. Therefore, the users 105 are required to enter the number of each item it wants to buy or sell only.

Also, the master user 120 determines (often in conjunction with the users 105) what items are “barterable items”. The master user 120 often selects the most standardized, high volume, high priced items which can be shipped efficiently and are least subject to wear and tear which increases the efficiency of the barter system.

The present invention provides a mechanism and entity to coordinate the actions of the barter participants in the best interests of the system 100. Often users 105 are related as part of a partnership, alliance, association or common ownership and share a common objective. Therefore, if imbalances exist between the supply and demand for a particular product across the entire barter system, the master user 120 can buy these excess items from users with virtual money and reduce its purchase of these same items with real money in the future.

The present invention has other advantages and the present invention does not require that all the advantageous features and all the advantages need to be incorporated into every embodiment of the present invention.

Although the present invention has been described in considerable detail with reference to certain preferred versions thereof, other versions are possible. For example, in one embodiment of the present invention the users 105 determine the barterable items. In another embodiment of the present invention, the exchange is “open” to users 105 not related to the master user 120 and other users 105. In another embodiment of the present invention, the user 105 may upload data to the database 132 regarding a barterable item including descriptions, photos, and other characteristics of the barterable items. In another embodiment of the present invention, the user 105 selects the pricing or points of the barterable items. In another embodiment of the present invention, the users 105 name is not anonymous. In another embodiment of the present invention, the users 105 are advanced points or credit and can therefore buy items even though they currently have nothing to sell. Therefore, the spirit and scope of the appended claims should not be limited to the description of the preferred versions contained herein.

Insofar as the description above and the accompanying drawing disclose any additional subject matter that is not within the scope of the single claim below, the inventions are not dedicated to the public and the right to file one of more applications to claim such additional inventions is reserved.

What is claimed is:

1. A method for transferring assets between related entities utilizing a master user, the method comprising the steps of:
a) providing a set of assets subject to transfer and a value for each asset;
b) providing at least some of the entities an account for containing points to obtain assets from another related entity;
c) receiving from at least one offering entity a list of assets available for transfer by the entity, the list being limited to the designated physical assets in the set;
d) receiving from at least one requesting entity a request to receive assets available for transfer;
e) transferring from the offering entity at least one of the assets listed as available for transfer to the requesting entity; and
f) deducting from the account of the requesting entity the transfer value for the asset received by requesting entity.

2. The method of claim 1 wherein the assets are services.

3. The method of claim 1 wherein the assets are physical assets.

4. The method of claim 3 wherein the step of transferring comprises transferring the physical asset to a main user and then transferring the physical asset to the requesting entity.

5. The method of claim 3 wherein step (b) comprises providing at least one entity points before the entity provides a list of physical assets available for transfer.

6. The method of claim 3 wherein step (b) comprises providing at least one entity points after the entity provides a list of physical assets and before any of that entity's physical assets are transferred in step (e).

7. The method of claim 3 comprising the additional step of crediting the account of the offering entity the transfer value of the physical asset received by the requesting entity.

8. The method of claim 3 wherein the received list is received anonymously.

9. The method of claim 3 wherein each offering entity's identity is unknown by the main user.

10. The method of claim 9 wherein each offering entity's identity is unknown by any other entity.

11. The method of claim 3 wherein the related entities are schools in the same school system.

12. The method of claim 3 wherein the master user also has an account and can provide a list of physical assets available for transfer by the administrator.

13. A method for transferring physical assets between related entities utilizing a master user, the method comprising the steps of:
a) providing a set of physical assets subject to transfer, and a transfer value for each asset;
b) receiving from at least one offering entity a list of physical assets available for transfer by the entity, the list being limited to the designated physical assets in the set, the identity of the offering entity not being known by any other entity;
c) providing the entities an account containing points to obtain physical assets from another related entity;
d) receiving from at least one requesting entity a request to receive physical assets available for transfer;
e) transferring from the offering entity at least one of the physical assets listed as available for transfer to the requesting entity by transferring the physical asset to a main user and then transferring the physical asset to the requesting entity; and
f) deducting from the account of the requesting entity the transfer value for the physical asset received by requesting entity,
wherein at least one entity is provided points after the entity provides a list of physical assets and before any of that entity's physical assets are transferred in step (e).

14. A barter system for transferring physical assets between related entities utilizing a distributed computer network, the system comprising:
a) one or more machine readable medium containing a database of designated physical assets, a transfer value for each asset, a list of the related entities, and an account for each entity, the account containing points to obtain physical assets from another related entity;
b) administrative computer means operably connected to the database for maintaining the database; and
c) at least one remote computer means for each of the related entities, the remote computers means operably connected to the database for (i) providing a list of physical assets available for transfer limited to designated physical assets in the database; and (ii) requesting transfer of physical assets listed in the database.

15. The system of claim 14 including a processor for deducting from the account of each entity transferring physical assets the transfer value for the physical assets received by that entity.

16. The system of claim 15 including a processor for crediting the account of each entity transferring physical assets the transfer value for the transferred physical assets by that entity.

17. The system of claim 14 including a processor for crediting the account of each entity transferring physical assets the transfer value for the transferred physical assets by that entity.

18. The system of claim 14 wherein the administrative computer means does not reveal the identity of any entity to another entity.

19. The system of claim 14 wherein the remote computers when providing a list of physical assets available for transfer maintain the identity of the entity anonymous.

20. The system of claim 14 wherein the account for at least one entity contains transfer points before that entity transfers any physical assets and before that entity provides a list of physical assets available for transfer.

21. The system of claim 14 the account for at least one entity contains transfer points after that entity provides a list of physical assets available for transfer and before that entity transfers any physical assets.

22. A barter system for transferring physical assets between related entities utilizing a distributed computer network, the system comprising:
a) one or more machine readable medium containing a database of designated physical assets, a transfer value for each asset a list of the related entities, and an account for each entity, the account containing points to obtain physical assets from another related entity;
b) administrative computer means operably connected to the database for maintaining the database;
c) at least one remote computer means for each of the related entities, the remote computers means operably connected to the database for (i) providing a list of physical assets available for transfer limited to designated physical assets in the database; and (ii) requesting transfer of physical assets listed in the database;
d) a first processor for deducting from the account of each entity transferring physical assets the transfer value for the physical assets received by that entity; and
e) a second processor for crediting the account of each entity transferring physical assets the transfer value for the transferred physical assets by that entity,
wherein the administrative computer means does not reveal the identity of any entity to another entity, and wherein the account for at least one entity contains transfer points after that entity provides a list of physical assets available for transfer and before that entity transfers any physical assets.

23. The system of claim 22 wherein the first and second processors are the same processor.

24. The method of claim 3 comprising the additional step of adding to the account of the offering entity the transfer value for the physical asset being transferred by the transferring entity.

25. The method of claim 3 wherein step (b) comprises providing at least one entity points after the entity provides a list of physical assets and before any of that entity's physical assets are the subject of a request in step (d).

26. The system of claim 1 wherein the step of deducting results in a negative balance in the account of the requesting entity.
